(19) United States
(12) Patent Application Publication
(10) Pub. No.: US 2021/0353972 A1
(43) Pub. Date: Nov. 18, 2021

(54) FACEMASK WITH REPLACEABLE FILTER

(71) Applicant: Diversified Industrial Technology, Inc., Kennesaw, GA (US)

(72) Inventors: Robert Adam, Kennesaw, GA (US); Sayyadina Beyer, Acworth, GA (US); Dan DeYoung, Woodstock, GA (US)

(21) Appl. No.: 17/320,550

(22) Filed: May 14, 2021

Related U.S. Application Data
(60) Provisional application No. 63/025,686, filed on May 15, 2020.

(51) Int. Cl. A62B 7/10; A62B 9/00; A62B 23/02; A62B 18/08; B01D 46/16; B01D 46/00; A41D 13/11

(52) U.S. Cl. CPC A62B 7/10; A62B 9/00; A62B 23/02; A62B 18/084; A62B 18/08; B01D 2271/02; B01D 46/0023; B01D 46/0004; A41D 13/1146; A41D 13/1161; B01D 46/16

(57) ABSTRACT

A facemask assembly includes a facemask including a face seal defining a first end and a second end, the first end at least partially defining a filter cavity, the second end configured to form a seal with a user's face; a filter cover coupled to the first end, the filter cover further defining the filter cavity; and a filter assembly positioned within the filter cavity; and a restraint coupled to the facemask, the restraint configured to secure the facemask to the user's face.

This application claims the benefit of U.S. Provisional Application 63/025,686, filed on May 15, 2020, which is hereby incorporated in its entirety by reference.

### TECHNICAL FIELD

This disclosure relates to facemasks. More specifically, this disclosure relates to a facemask with a replaceable filter.

### BACKGROUND

Facemasks are worn for a variety of uses, such as to filter out harmful particles, such as asbestos or sawdust, or biologically hazardous bodies, such as bacteria and viruses.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a facemask assembly comprising a facemask comprising a face seal defining a first end and a second end, the first end at least partially defining a filter cavity, the second end configured to form a seal with a user's face; a filter cover coupled to the first end, the filter cover further defining the filter cavity; and a filter assembly positioned within the filter cavity; and a restraint coupled to the facemask, the restraint configured to secure the facemask to the user's face.

Also disclosed is a method for using a facemask assembly, the method comprising positioning a filter assembly of the facemask assembly within a filter cavity at least partially defined by a face seal of the facemask assembly, the face seal defining a first end and a second end, the filter cavity extending into the first end of the face seal; and securing a filter cover of the facemask assembly to the first end to at least partially enclose the filter cavity.

Also disclosed is a method for using a facemask assembly, the method comprising filling a pan with hot water; dipping a face portion of a face seal of the facemask assembly into the hot water for a first time duration to soften the face portion; and pressing the face portion against a face of a user to form a seal between the face portion and the face until the face portion hardens after a second time duration.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is a perspective front view of a facemask assembly comprising a facemask and a restraint in accordance with one aspect of the present disclosure.

FIG. 2 is a perspective rear view of the facemask assembly of FIG. 1.

FIG. 3 is a perspective rear view of the facemask assembly of FIG. 1 with the facemask in an exploded state.

FIG. 4 is a perspective front view of the facemask assembly of FIG. 1 with the facemask in an exploded state.

FIG. 5 is a front view of a face seal of the facemask of FIG. 1.

FIG. 6 is a rear view of the face seal of the facemask of FIG. 1.

FIG. 7 is a perspective side view of the face seal of the facemask of FIG. 1.

FIG. 8 is a front view of a filter cover of the facemask of FIG. 1.

FIG. 9 is a perspective rear view of the filter cover of the facemask of FIG. 1.

FIG. 10 is a cross-sectional view of the facemask assembly of FIG. 1, taken along line 10-10 shown in FIG. 2, with a filter assembly of the facemask removed from a filter cavity of the facemask.

FIG. 11A is a side view of the facemask of FIG. 1 demonstrating a first step in the assembly of the facemask.

FIG. 11B is a side view of the facemask of FIG. 1 demonstrating a second step in the assembly of the facemask.

FIG. 11C is a side view of the mask portion of the facemask of FIG. 1 demonstrating a third step in the assembly of the facemask.

FIG. 11D is a side view of the mask portion of the facemask of FIG. 1 demonstrating a fourth step in the assembly of the facemask.

FIG. 12 is a side view of the face seal of the facemask of FIG. 1 partially submerged in water.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a facemask assembly and associated methods, systems, devices, and various apparatus. The facemask assembly can comprise a facemask and a restraint. It would be understood by one of skill in the art that the disclosed facemask assembly is described in but a few exemplary embodiments among many. No particular terminology or description should be considered limiting on the disclosure or the scope of any claims issuing therefrom.

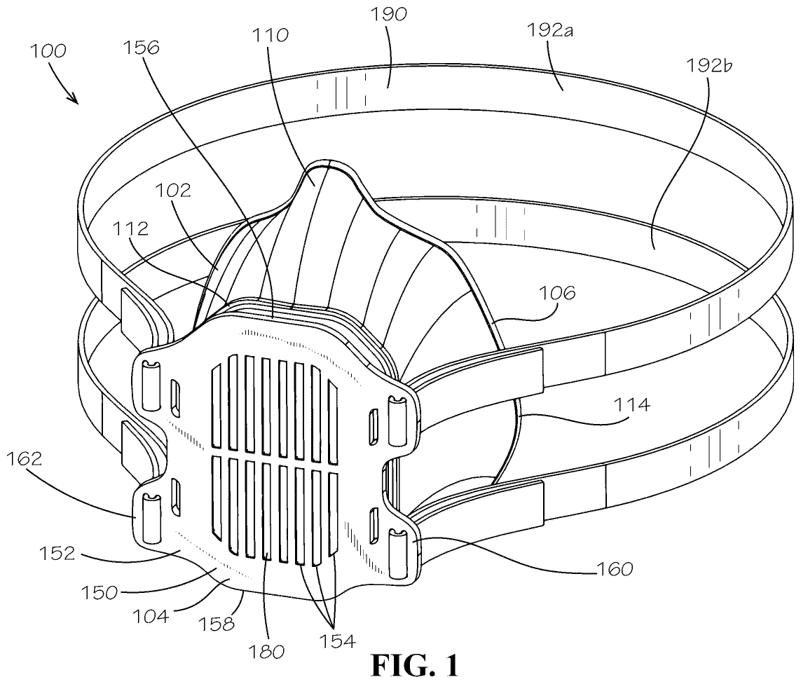

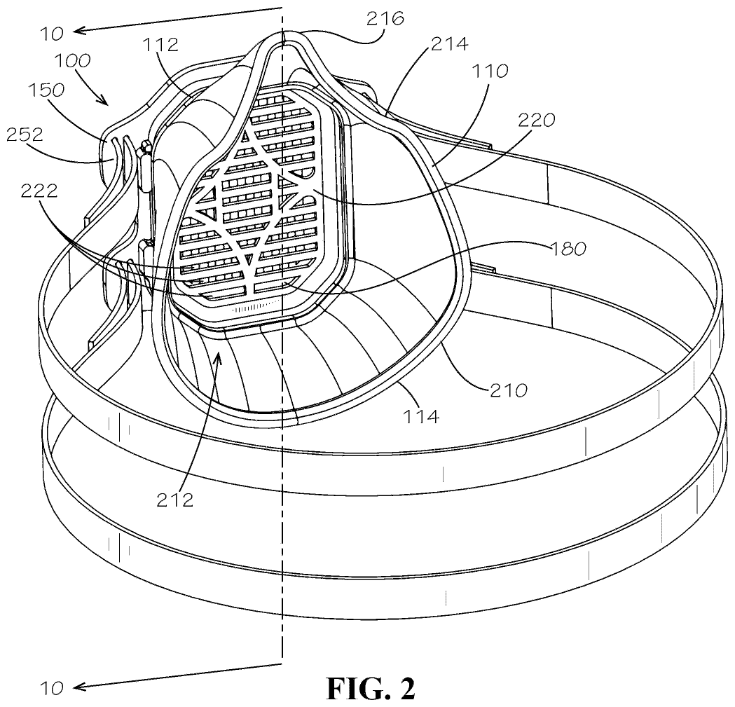

FIG. 1 is a perspective front view of a facemask assembly 100 comprising a facemask 102 and a restraint 190. The facemask 102 can comprise a face seal 110, a filter cover 150, and a filter assembly 180. The filter cover 150 can define an outer surface 152 and an inner surface 252 (shown in FIG. 2). The outer surface 152 can define a front end 104 of the facemask 102.

The face seal 110 can define first end 112 and a second end 114. The first end 112 can be disposed opposite from the second end 114. The first end 112 can be coupled to the filter cover 150. The second end 114 can be configured to seal against a face of a user (not shown) of the facemask assembly 100. The second end 114 can define a back end 106 of the facemask 102.

The filter cover 150 can define a plurality of openings 154 extending through the filter cover 150 from the outer surface 152 to the inner surface 252 (shown in FIG. 2). In the present aspect, the outer surface 152 and the inner surface 252 can be substantially planar. In some aspects, the filter cover 150 can be curved and can wrap at least partially around the sides of the face seal 110 towards a user's cheeks, nose, and/or chin. A curved aspect of the filter cover 150 can provide greater surface area to the filter assembly 180, which can increase breathability through the filter assembly 180 and increase the use duration of the filter assembly 180 before the filter assembly 180 becomes dirty and/or clogged.

In the present aspect, the plurality of openings 154 can be a plurality of elongated slots aligned substantially vertically between a top end 156 of the filter cover 150 and a bottom end 158 of the filter cover 150. In other aspects, the elongated slots can be aligned in a different orientation, such as horizontally between a left side 160 and a right side 162 of the filter cover 150 (labelled with respect to a user's left and right sides), in a radial pattern, or any other suitable arrangement. In other aspects, the plurality of openings 154 can be a plurality of apertures, such as holes of circular, oval, square, or any other suitable shape. In some aspects, the plurality of openings 154 can have a mix of openings of different sizes, shapes, and/or arrangements.

The plurality of openings 154 can be configured to permit sufficient air flow through the filter cover 150 while also providing support for the filter assembly 180 (visible through the plurality of openings 154), which can be captured between the filter cover 150 and the face seal 110. In some aspects, the filter assembly 180 can comprise one or more compressible materials, such as a foam for example and without limitation, and the filter assembly 180 can be compressed between the filter cover 150 and the face seal 110.

In the present aspect, the restraint 190 can comprise a first strap 192a and a second strap 192b. In other aspects, the restraint 190 can comprise greater or fewer than two straps 192a,b. In some aspects, the restraint 190 can comprise a harness (not shown) comprising multiple interconnected straps.

In the present aspect, the restraint 190 can couple to the filter cover 150. Specifically, the restraint 190 can couple to the left side 160 and the right side 162 of the filter cover 150. In some aspects, the restraint 190 can couple to other portions of the filter cover 150, such as the top end 156 and/or bottom end 158, either in addition to or in substitute of coupling with the left side 160 and the right side 162. In some aspects, the restraint 190 can couple to a different portion of the facemask 102, such as the face seal 110, for example and without limitation.

FIG. 2 is a perspective rear view of the facemask assembly 100 of FIG. 1. The face seal 110 can define a face cavity 212 extending from the second end 114 to a filter support 220 of the face seal 110. The face cavity 212 can extend inwards into the face seal 110 from the second end 114 towards the first end 112. The second end 114 can define an opening 210 to the face cavity 212, and the opening 210 can be shaped complimentary to a user's face. For example and without limitation, the opening 210 can define a nose guard 214 near a top tend 216 of the face seal 110, which can be narrowed and scalloped to seal with a bridge of a user's nose.

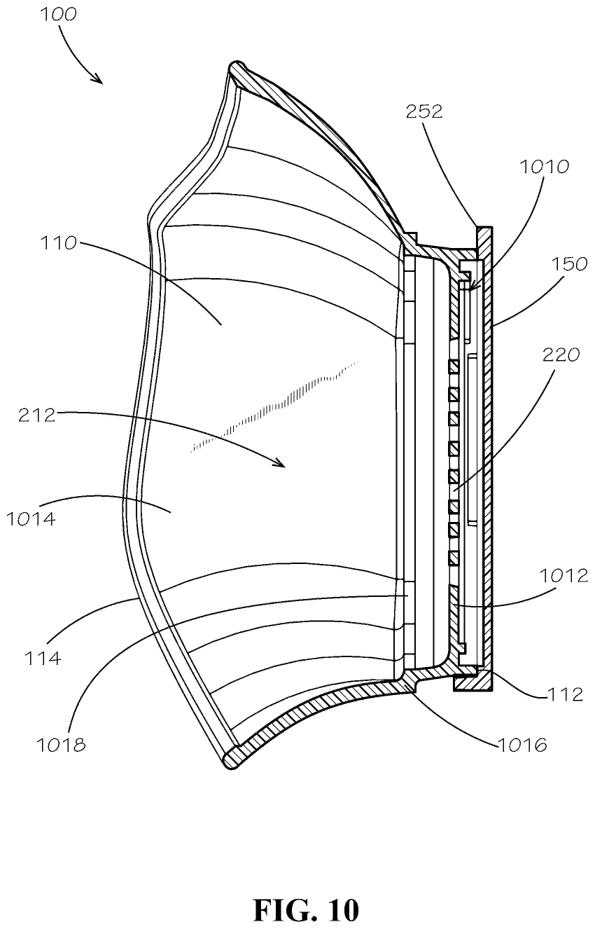

The filter support 220 can be positioned between the first end 112 and the second end 114. The filter support 220 can be a permeable physical barrier between the face cavity 212 and a filter cavity 1010 (shown in FIG. 10) defined between the filter support 220 and the inner surface 252 of the filter cover 150. The filter support 220 can define a plurality of openings 222 extending through the filter support 220 between the face cavity 212 and the filter cavity 1010, which can allow air to pass through the filter support 220. In the present aspect, the plurality of openings 222 can be a plurality of substantially horizontal elongated slots. In other aspects, the elongated slots can be aligned in a different orientation, such as being vertically oriented, in a radial pattern, or any other suitable arrangement. In other aspects, the plurality of openings 222 can be a plurality of apertures, such as holes of circular, oval, square, or any other suitable shape. In some aspects, the plurality of openings 222 can have a mix of openings of different sizes, shapes, and/or arrangements.

In the present aspect, the filter assembly 180 (visible through the plurality of openings 222) can be compressed between the filter cover 150 and the filter support 220. The horizontal orientation of the plurality of openings 222 of the filter support 220 can be substantially perpendicular to the orientation of the plurality of openings 154 (shown in FIG. 1) of the filter cover 150, which can be configured to evenly compress the filter assembly 180 without causing localized pinching, or over-compression, that could limit air flow through the filter assembly 180. The perpendicular arrangement of two plurality of openings 154,222 can also be configured to provide greater diffusion of an air flow drawn through the filter cover 150, the filter assembly 180, and the filter support 220 and into the face cavity 212. Greater diffusion of the air flow causes particulates captured by the filter assembly 180 to be more uniformly distributed throughout the filter assembly 180, which can prolong the life of the filter assembly 180 as it becomes dirty.

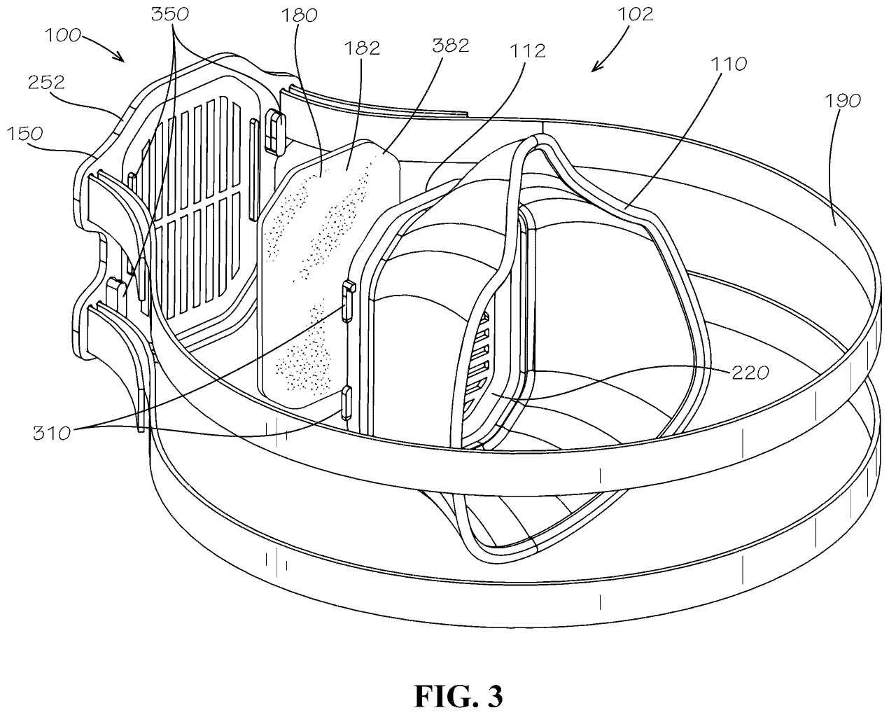

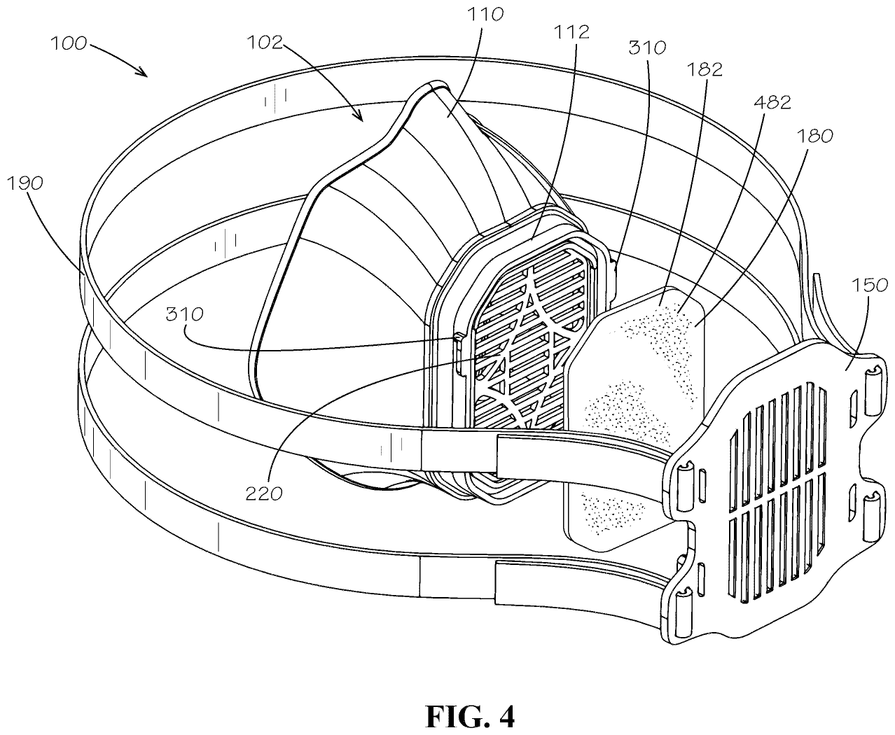

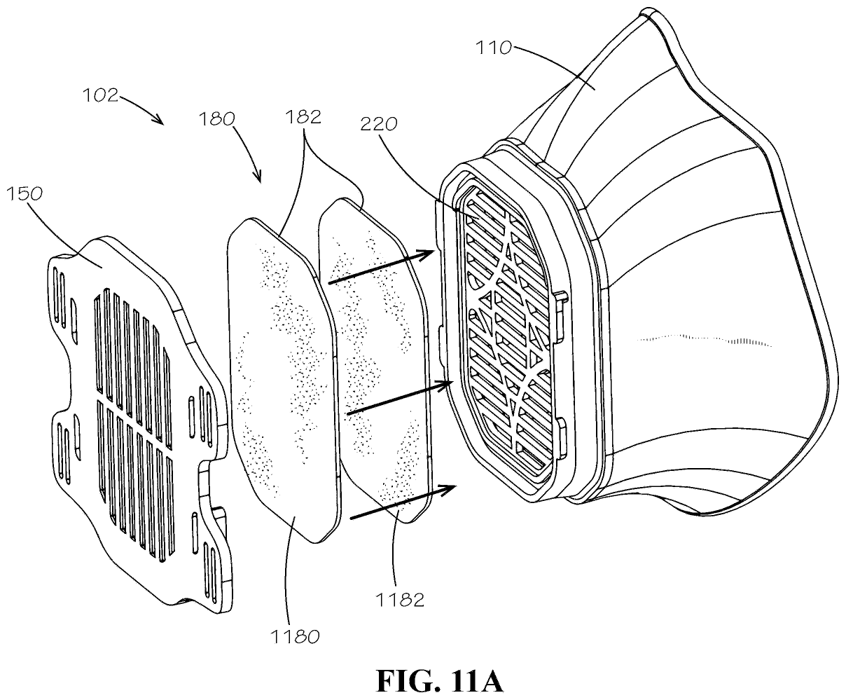

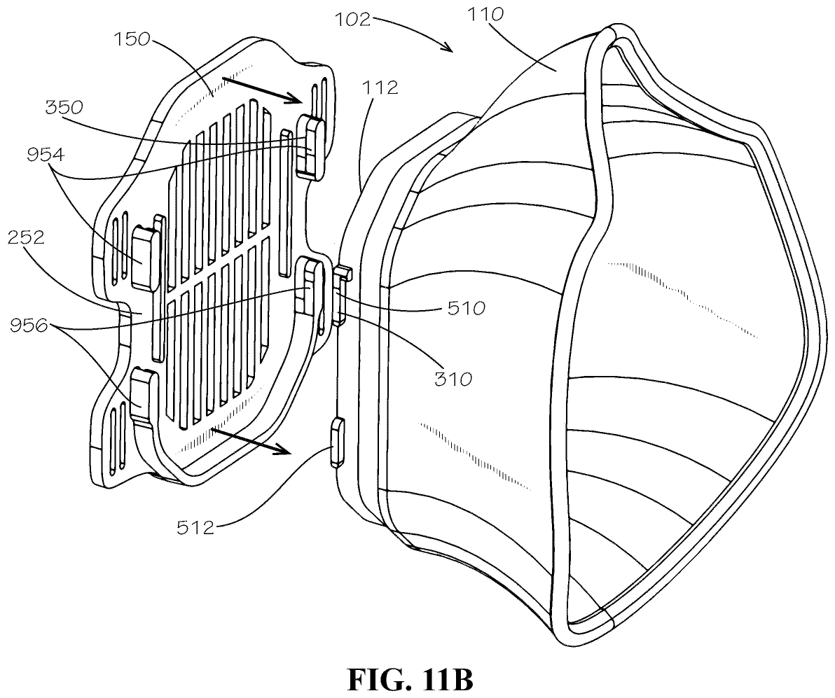

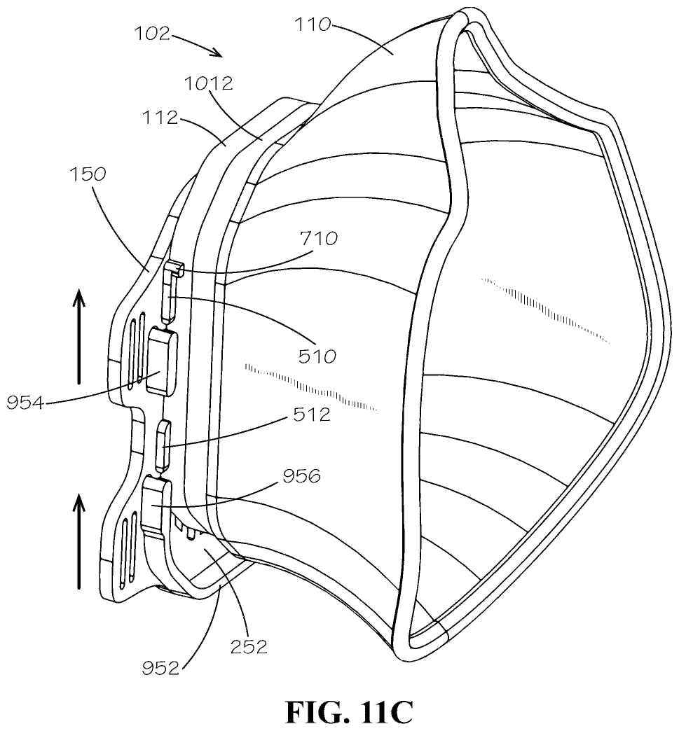

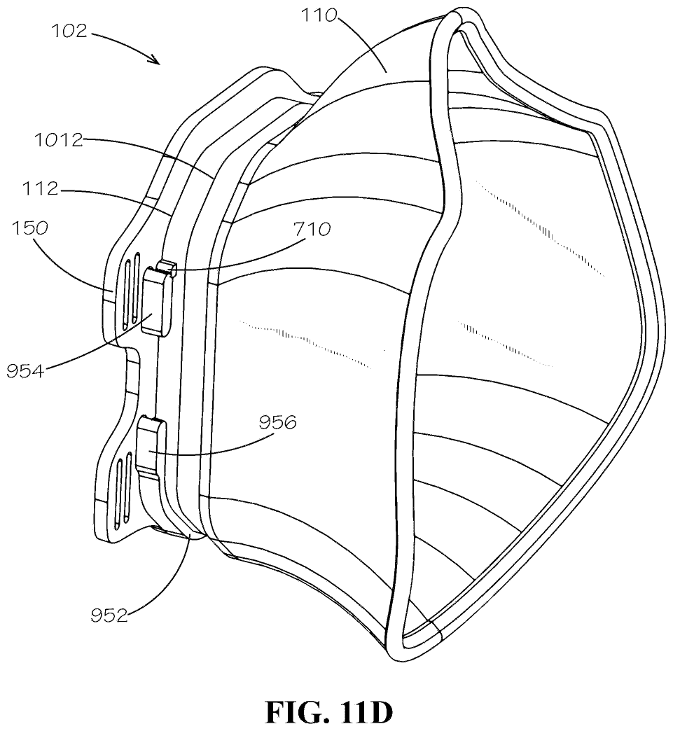

FIG. 3 is a perspective rear view of the facemask assembly 100 of FIG. 1 with the facemask 102 in an exploded state. FIG. 4 is a perspective front view of the facemask assembly 100 of FIG. 1 with the facemask 102 in the exploded state. In the aspect shown, the filter assembly 180 can comprise a single filter 182. However, as shown in FIG. 11A, the filter assembly 180 can comprise two or more filters 182. Each filter 182 can define an inner surface 382 (shown in FIG. 3) and an outer surface 482 (shown in FIG. 4).

The inner surface 382 can face the filter support 220, and the outer surface 482 can face the filter cover 150. Apart from any inherent roughness of the filter material, the surfaces 382,482 can be substantially planar in the present aspect. In other aspects, the filter 182 and surfaces 382,482 can define a different shape. For example, the filter assembly 180 can be shaped as a cylindrical segment, a hemispherical shell, or any other suitable shape, for example and without limitation, and the filter cover 150 and the face seal 110 can be shaped complimentary to the filter assembly 180. Incorporation of a curved surface in the filter assembly 180 can increase the surface area of the surfaces 382,482.

As shown in FIG. 3, the filter cover 150 can define a plurality of cover lugs 350. In the aspect shown, the cover lugs 350 can be defined protruding from the inner surface 252. The face seal 110 can define a plurality of seal lugs 310 at the first end 112. The cover lugs 350 and the seal lugs 310 can engage together and cooperate to secure the filter cover 150 to the first end 112 of the face seal 110, as shown and further described below with respect to FIGS. 11A-D. With the filter assembly 180 positioned in the filter cavity 1010 (shown in FIG. 10) and the filter cover 150 coupled to the face seal 110 via engagement of the lugs 310,350, the filter assembly 180 can be compressed against the filter support 220 to form a seal and prevent air from leaking around or otherwise bypassing the filter assembly 180.

Additionally, the restraint 190 can provide redundant support for the filter assembly 180 in the event that the lugs 310,350 were to disengage or fail. The restraint 190 can comprise a resilient material, such as an elastomer for example and without limitation, which can stretch over a user's head and press the facemask 102 against the user's face. Because the restraint 190 is coupled to the filter cover 150, the restraint 190 presses the filter cover 150 against the face seal 110. The elastic force provided by the restraint 190 can be sufficient to overcome the expansive force of the compressed filter assembly 180, thereby maintaining the compressed state of the filter assembly 180 and the seal between the filter assembly 180 and the filter support 220, in the event that the lugs 310,350 disengage or fail.

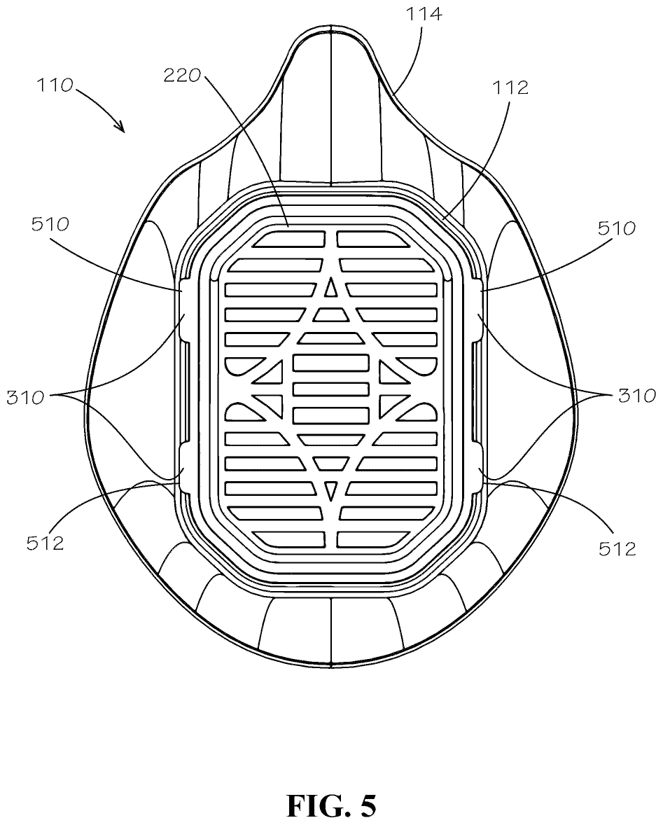

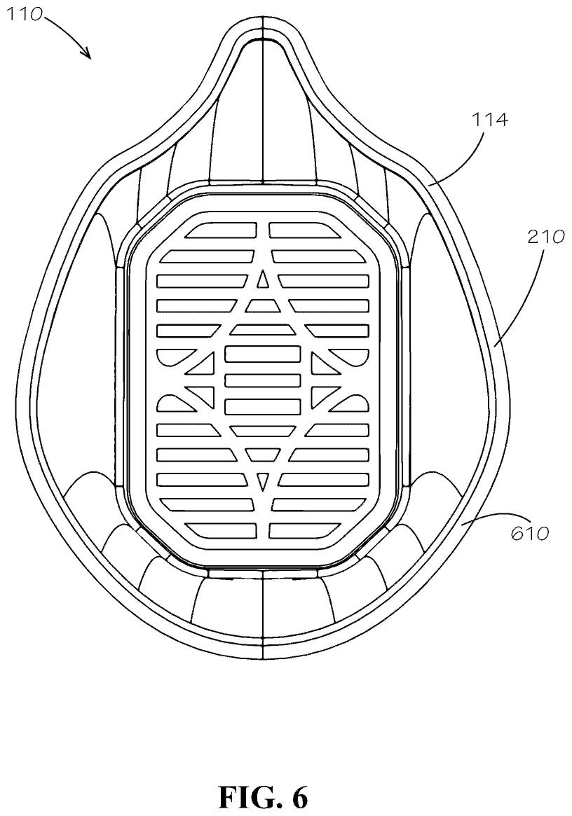

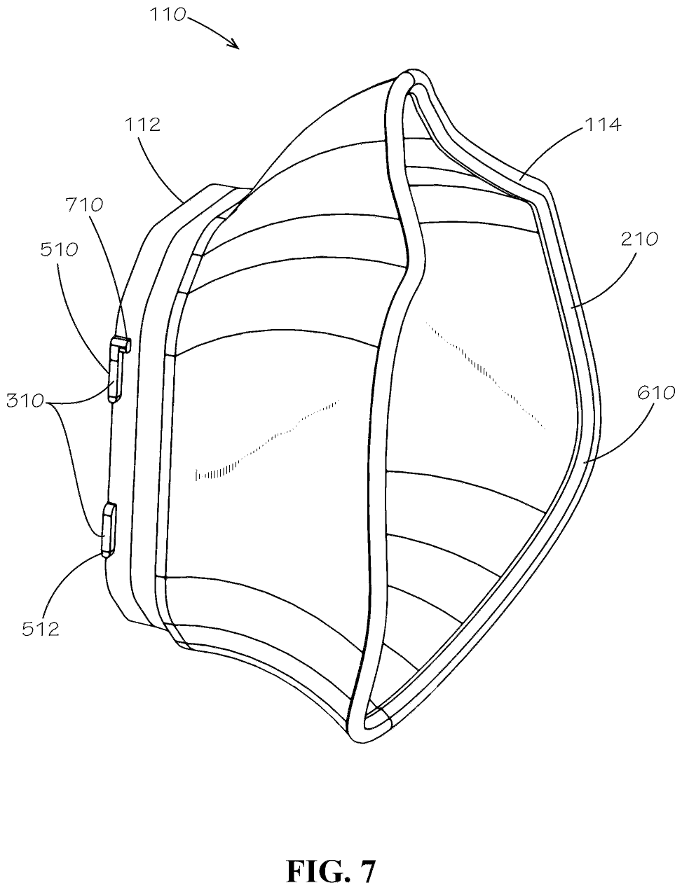

FIG. 5 is a front view of the face seal 110 of the facemask 102 of FIG. 1. FIG. 6 is a rear view of the face seal 110 of the facemask 102 of FIG. 1. FIG. 7 is a perspective side view of the face seal 110 of the facemask 102 of FIG. 1. As shown in FIGS. 5 and 7, the plurality of seal lugs 310 can be distributed around the filter support 220 at the first end 112 of the face seal 110. In the present aspect, the plurality of seal lugs 310 can comprise a pair of upper seal lugs 510 and a pair of lower seal lugs 512. As shown in FIG. 7, the upper seal lugs 510 can define an upper shoulder 710 configured to limit upward motion of the filter cover 150 (shown in FIG. 1) relative to the face seal 110 when the filter cover 150 is secured to the face seal 110.

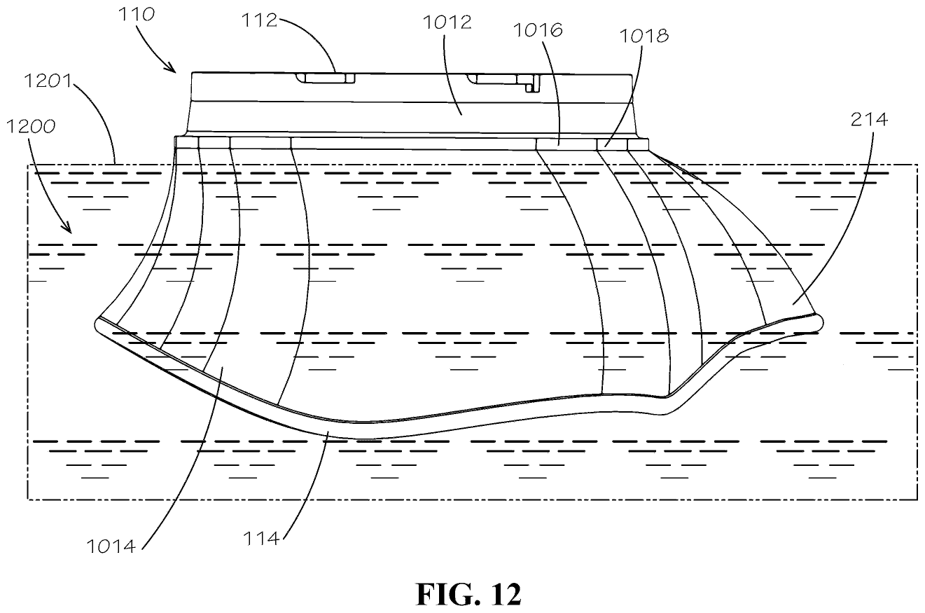

As shown in FIGS. 6 and 7, the second end 114 can define a bead 610 extending around the opening 210. The bead 610 can be defined by a thickened portion of material. In the present aspect, the bead 610 can define a substantially rounded profile. The bead 610 can reinforce the second end 114 of the face seal 110, such as to prevent tears of the face seal 110 and to better hold a shape of the opening 210 at the second end 114 when the face seal 110 is custom fit to the user's face, as further described below with respect to FIG. 12.

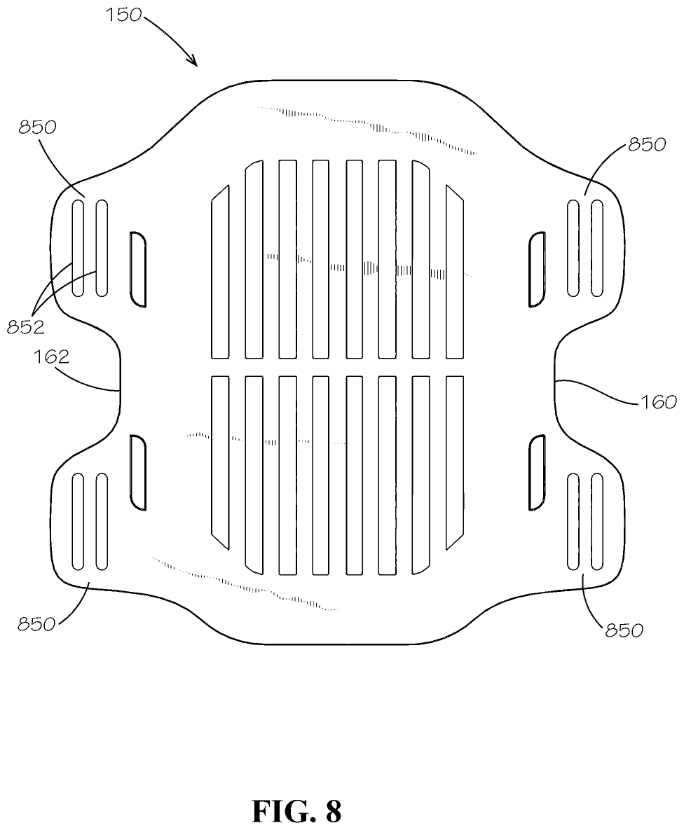

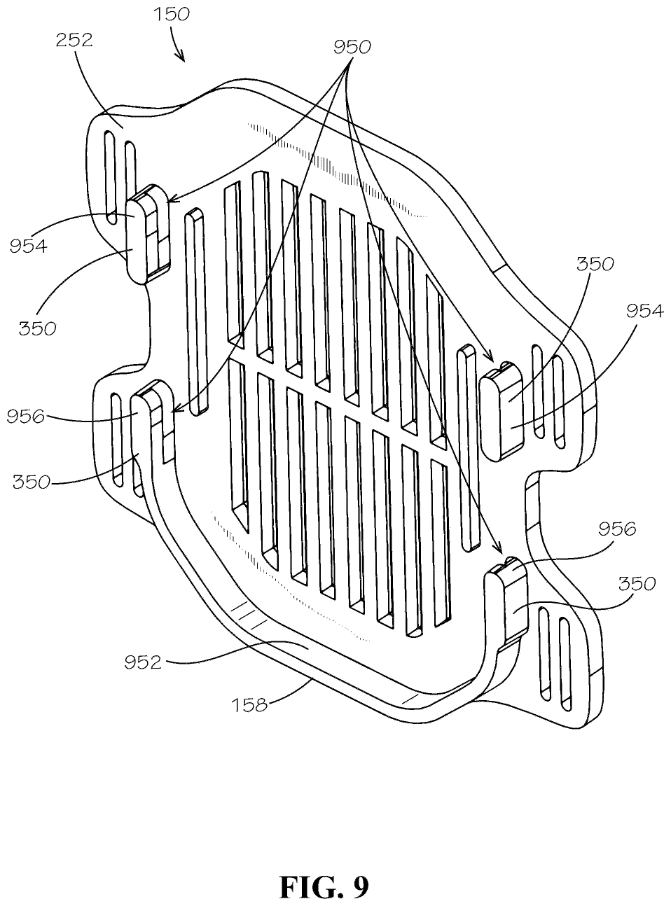

FIG. 8 is a front view of the filter cover 150 of the facemask 102 of FIG. 1. FIG. 9 is a perspective rear view of the filter cover 150 of the facemask 102 of FIG. 1. As shown in FIG. 8, each side 160,162 of the filter cover 150 can define restraint mounting points 850. As demonstrated by the top left restraint mounting point 850 (with respect to the present viewing angle), each restraint mounting point 850 can define a pair of slots 852 configured to receive a strap 192a,b (shown in FIG. 1) of the restraint 190 (shown in FIG. 1) to couple the filter cover 150 to the restraint 190. The straps 192a,b can be pulled through the slots 852 to adjust a fit of the facemask assembly 100 (shown in FIG. 1) around a user's head.

As shown in FIG. 9, the plurality of cover lugs 350 can protrude outwards from the inner surface 252 of the filter cover 150, and grooves 950 can be formed between the plurality of cover lugs 350 and the inner surface 252. The grooves 950 can be configured to receive the seal lugs 310 (shown in FIG. 3) to couple the filter cover 150 to the face seal 110 (shown in FIG. 1). The plurality of cover lugs 350 can comprise a pair of upper cover lugs 954 and a pair of lower cover lugs 956. In the present aspect, a bottom lip 952 can extend along the bottom end 158 of the filter cover 150 between the lower cover lugs 956. The bottom lip 952 can be configured to limit upward travel of the filter cover 150 relative to the face seal 110 when the filter cover 150 is coupled to the face seal 110.

FIG. 10 is a cross-sectional view of the facemask assembly 100 of FIG. 1, taken along line 10-10 shown in FIG. 2, with the filter assembly 180 (shown in FIG. 1) removed from the filter cavity 1010 for clarity. The face seal 110 can comprise a filter portion 1012 and a face portion 1014, which can be connected at an interface 1016. The filter portion 1012 can extend from the first end 112 to the interface 1016, and the face portion 1014 can extend from the second end 114 to the interface 1016. In the present aspect, a flange 1018 can be defined at the interface 1016.

The filter portion 1012 can be configured to provide a rigid structure for compressing and sealing with the filter assembly 180 (shown in FIG. 1) and coupling to the filter cover 150. The filter portion 1012 can comprise the filter support 220, the plurality of seal lugs 310 (shown in FIG. 1), and the first end 112. The filter cavity 1010 can be defined between the inner surface 252 of the filter cover 150 and the filter support 220, and the filter cavity 1010 can be at least partially defined within the filter portion 1012.

The face portion 1014 can be configured to conform to a user's face in order to form a seal that prevents air from entering the face cavity 212 without passing through the filter assembly 180. The face portion 1014 can be resilient and flexible, while also demonstrating a positional memory that can be custom fit to a user's face.

In some aspects, the rigidity and flexibility of the respective portions 1012,1014 can be controlled by varying the material thickness of the face seal 110 over those portions. For example and without limitation, the face portion 1014 can be thinner than the filter portion 1012. In some aspects, the face portion 1014 can increase in thickness from the second end 114 towards the interface 1016 so that the second end 114 is thinner and more capable of forming a seal with a user's face. For example and without limitation, the face seal 110 can be around 0.040″ in thickness at or near the second end 114, and the face portion 1014 of the face seal 110 can increase in thickness closer to the interface 1016.

In some aspects, the filter portion 1012 and the face portion 1014 can comprise different materials. For example and without limitation, the filter portion 1012 can comprise a more rigid material, such as polypropylene, and the face portion 1014 can comprise a more flexible material, such as polyethylene. In some aspects, the different materials can be integrally molded together at the interface 1016. In other aspects, the different portions 1012,1014 can be coupled together at the interface 1016, such as with an adhesive or mechanical connection, for example and without limitation.

In some aspects, the filter portion 1012 and the face portion 1014 can comprise the same material but with different density. For example and without limitation, the filter portion 1012 can comprise high density polyethylene, and the face portion 1014 can comprise low density polyethylene, for example and without limitation.

FIGS. 11A-D are perspective side views demonstrating steps for assembling the facemask 102 of the facemask assembly 100 of FIG. 1.

As shown in FIG. 11A, the filter assembly 180 can be placed between the filter cover 150 and the face seal 110 and against the filter support 220 of the face seal 110. In aspects of the filter assembly 180 comprising multiple filters 182 as shown, a first filter can be an outer filter 1180, and a second filter can be an inner filter 1182. The outer filter 1180 can be positioned to contact the filter cover 150, and the inner filter 1182 can be positioned to contact the filter support 220. In aspects comprising more than two filters 182, any additional middle filters can be sandwiched between the outer filter 1180 and the inner filter 1182.

In some aspects, the filters 182 can be identical, and the placement of the filters 182 relative to one another may not be important. In some aspects, the filters 182 can be different from one another, with one intended to be the outer filter 1180 and one or more intended to be the inner filter 1182 (and middle filters, if applicable). For example, in some aspects, the outer filter 1180 can be a more open filter only configured to filter out larger particles, and the inner filter 1182 can be a finer filter configured to filter out smaller particles. The outer filter 1180 can act as a pre-filter that can keep the larger particles from quickly clogging the inner filter 1182. In some aspects, the outer filter 1180 can be cleanable and reusable. Because finer filters 1182 tend to have smaller pores or air passageways, it can become difficult to breathe through as it becomes dirty. By contrast, pre-filters have larger openings that can capture large particles while still being relative easy to breathe through. Use of the pre-filter in conjunction with the inner filter 1182 allows the filter assembly 180 to filter out more particles before breathability and filtration are compromised compared to the inner filter 1182 alone. Often finer filters, such as those used to filter out biological agents (such as viruses and bacteria), are also more expensive whereas course filters are less expensive. Use of cheap disposable or reusable outer filters 1180 can prolong the life of more expensive finer filters at the inner filter 1182 position.

In some aspects, the outer filter 1180 can be a material selected for its compressibility and resilience, such as a foam material. The outer filter 1180 can compress between the filter cover 150 and the inner filter 1182 to bias the inner filter 1182 against the filter support 220 to form a seal between the inner filter 1182 and the filter support 220. This sealing mechanism can be more robust and resilient compared to the use of an adhesive or sealant between the filter assembly 180 and face seal 110, which can fail as the bond weakens. In existing facemasks, seals between the filter material and mask are a known failure points because they are subjected to material fatigue. As the user inhales and exhales, the forces on the seal reverse between compressive and tensile states as a result of the respective partial vacuum and positive pressure produced by the breathing cycle. The resulting stress cycles fatigue the material until the seal fails. With the facemask 102, the seal between the filter assembly 180 and the face seal 110 is maintained in a compressive state, which minimizes fatigue of the materials due to the user's breathing.

Turning to FIG. 11B, with the filters 182 positioned against the filter support 220, the filter cover 150 can be aligned with the face seal 110 in preparation for installation of the filter cover 150 on the face seal 110. In the present aspect, the lugs 310,350 can be aligned in a position that does not cause interference and permits the filter cover 150 to be placed in facing contact with the first end 112 of the face seal 110. In the present aspect, the upper cover lugs 954 can be aligned between the upper seal lugs 510 and lower seal lugs 512, and the lower cover lugs 956 can be aligned below the lower seal lugs 512.

With the filter cover 150 aligned with the face seal 110 as described, the inner surface 252 of the filter cover 150 can be positioned in facing engagement with the first end 112 of the face seal 110, as shown in FIG. 11C. In other aspects, each side of the face seal 110 and filter cover 150 can respectively define a single elongated lug. In such aspects, the lugs 350 of the filter cover 150 can be placed above or below the lugs 310 of the face seal 110 before placing the inner surface 252 in facing engagement with the first end 112.

With the inner surface 252 in facing engagement with the first end 112, the filter cover 150 can then be slid upwards relative to the face seal 110 so that the plurality of seal lugs 310 engage the pair of grooves 950 (shown in FIG. 9), thereby engaging the plurality of seal lugs 310 with the plurality of cover lugs 350. The filter cover 150 can be slid upwards until the upper cover lugs 954 contact the upper shoulder 710 and/or the bottom lip 952 contacts the filter portion 1012 of the face seal 110, thereby limiting further upward travel of the filter cover 150, as shown in FIG. 11D. In some aspects, the filter cover 150 can be configured to slide onto the face seal 110 in a different direction, such as sliding downwards, left-to-right, or right-to-left. In such aspects, the lugs 310,350 (shown in FIG. 3), shoulder 710, and lip 952 can be reoriented to accommodate these engagement directions.

The filter assembly 180 (shown in FIG. 1) can be changed out or cleaned by performing these steps in reverse order, swapping or cleaning the filter assembly 180, and then repeating the steps in the same order as described above.

FIG. 12 is a side view of the face seal 110 of the facemask assembly 100 of FIG. 1 partially submerged in water 1200, demonstrating a method for custom-fitting the face seal 110 to a user's face. In the present aspect, the face seal 110 can comprise an amorphous solid that is predominantly in a semi-transitional state, such as low density polyethylene, for example and without limitation. This material can be heated to facilitate reshaping of the face portion 1014 and then cooled to cause the face portion 1014 to hold its new shape. The following process describes steps that can be used to custom-fit the face portion 1014. In the present aspect, this process can be performed repeatedly to re-fit the face seal 110 to the same or a different user as needed.

First, the user can fill two pans with room temperature water 1200 and place the face seal 110 in each pan one at a time, with the first end 112 above the water 1200 and the second end 114 submerged in the water 1200. A water level 1201 of the water 1200 in each pan can be adjusted so that the water level 1201 is approximately ½″ above the nose guard 214. This water level 1201 should position a majority of the face portion 1014 underwater and the filter portion 1012, interface 1016, and flange 1018 above the water 1200.

Once the water level 1201 has been adjusted in each of the pans and the face seal 110 has been removed from the water 1200, one of the pans can be heated until the water 1200 boils while one of the pans is kept with the water 1200 at room temperature. The second end 114 of the face seal 110 can then be carefully submerged into the boiling water for approximately 1 minute.

The face seal 110 can then be withdrawn from the boiling water, and the second end 114 can be dipped into the room-temperature water for approximately two seconds. The face portion 1014 of the face seal 110 can then be pressed against the user's face using even pressure on both sides of the face seal 110 and the nose guard 214 for approximately 30 seconds. The second end 114 of the face seal 110 can then be placed back in the room temperature water for approximately 30 seconds so that the material of the face seal 110 can harden. The seal of the face seal 110 with the user's face can be checked, and the process can be repeated as necessary to achieve a proper seal.

To check the seal, the user can cover the first end 112 with their hand while wearing the face seal 110 and exhale to see if air escapes the mask. The user can then inhale and hold their breath for approximately 10 seconds to detect if air leaks into the face seal 110. If air does not leak into or out of the face seal 110 during these tests, then a proper seal has been achieved.

One advantage of the replaceable filter assembly 180 is that a user can custom fit the face seal 110 to their face one time and then reuse it without having to refit a new mask after each use. This can save time over disposable masks where the user must fit a new mask to their face for each use. Also, as the act of putting on a disposable mask becomes routine, many users do not take the time to ensure that they have achieved a proper seal at each use. This can be avoided by properly fitting the face seal 110 a single time. The custom-molded face seal 110 can also offer a more robust seal than provided by many disposable masks.

The facemask assembly 100 also offers particular advantages related to the hardships associated with the COVID-19 pandemic. At the civilian level, the general public has been advised to wear masks, but masks are in short supply. This is a significant issue because most masks are not meant to be reused, and replacements are not readily available. Making homemade face masks from household fabrics is time consuming and requires more skill than some individuals may possess. The design of the filter assembly 180 is well-suited for use with homemade filters. For example, in some aspects, the outer filter 1180 can comprise a cleanable and re-usable foam, such as reticulated polyurethane foam for example and without limitation. This resilient, compressible material can readily be used with homemade inner filters 1182 comprised of household materials, such as linens, clothing, or paper products, for example and without limitation. The outer filter 1180 can compress to varying degrees to accommodate inner filters 1182 of varying thickness while still ensuring a proper seal between the inner filter 1182 and the filter support 220. These simple homemade inner filters 1182 can be washed or discarded as needed, such as when they become moist from the wearer's breath, and new inner filters 1182 can be made, such as by placing a template on a new piece of material and cutting the material to the shape of the template. If no inner filters 1182 are available, the facemask assembly 100 can be used with only the outer filter 1180 in place, which can still prevent spreading of the virus.

In United States hospitals, frontline healthcare workers are forced to wear masks made of material meeting or exceeding the U.S. National Institute for Occupational Safety and Health (NIOSH) N95 standard, if available, in order to protect themselves. Filtration material meeting the N95 standard is only made by a few manufacturers, and is very scarce during the pandemic. Because of shortages, healthcare workers are sometimes using their masks too long, to the point that the effectiveness of the protection offered by the masks degrades. The amount of material required to make a disposable N95-rated mask is more than three times the amount needed to make a filter 182 for the filter assembly 180. Therefore, with the limited supply of N95 filter material available, the medical community could get more uses out of filters 182 made of N95 material than disposable masks made of N95 material. Additionally, as described above, use of a pre-filter as the outer filter 1180 can prolong the life of a piece of N95 material compared to using the N95 material without a pre-filter.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A facemask assembly comprising:
a facemask comprising:
a face seal defining a first end and a second end, the first end at least partially defining a filter cavity, the second end configured to form a seal with a user's face;
a filter cover coupled to the first end, the filter cover further defining the filter cavity; and
a filter assembly positioned within the filter cavity; and
a restraint coupled to the facemask, the restraint configured to secure the facemask to the user's face.

2. The facemask assembly of claim 1, wherein the restraint couples to the filter cover.

3. The facemask assembly of claim 1, wherein the filter assembly is compressed between the filter cover and the face seal.

4. The facemask assembly of claim 1, wherein the filter assembly comprises an outer filter positioned in facing contact with the filter cover and an inner filter positioned in facing contact with a filter support of the face seal.

5. The facemask assembly of claim 4, wherein:
the outer filter defines a plurality of pores of a first size;
the inner filter defines a plurality of pores of a second size; and
the first size is larger than the second size.

6. The facemask assembly of claim 4, wherein the filter support is positioned between the filter cavity and a face cavity extending into the face seal from the second end.

7. The facemask assembly of claim 1, wherein:
the face seal comprises a filter portion defining the first end and a seal portion defining the second end;
the filter portion is integrally molded with the seal portion;
the filter portion comprises a first material;
the seal portion comprises a second material; and
the first material is different from the second material.

8. A method for using a facemask assembly, the method comprising:
positioning a filter assembly of the facemask assembly within a filter cavity at least partially defined by a face seal of the facemask assembly, the face seal defining a first end and a second end, the filter cavity extending into the first end of the face seal; and
securing a filter cover of the facemask assembly to the first end to at least partially enclose the filter cavity.

9. The method of claim 8, further comprising pulling a restraint over a head of a user and forming a seal between the second end and a face of the user, the restraint being coupled to the filter cover.

10. The method of claim 8, wherein securing the filter cover of the facemask assembly to the first end to at least partially enclose the filter cavity comprises compressing the filter assembly with the filter cover.

11. The method of claim 8, wherein positioning the filter assembly of the facemask assembly within the filter cavity comprises:
positioning an inner filter of the filter assembly within the filter cavity in facing engagement with a filter support of the face seal; and
positioning an outer filter atop the inner filter to position the inner filter between the outer filter and the filter support.

12. The method of claim 11, wherein:
the outer filter defines a plurality of pores of a first size;
the inner filter defines a plurality of pores of a second size; and
the first size is larger than the second size.

13. The method of claim 8, wherein securing the filter cover of the facemask assembly to the first end to at least partially enclose the filter cavity comprises engaging at least one lug of the filter cover with at least one lug of the face seal.

14. The method of claim 13, wherein engaging the at least one lug of the filter cover with the at least one lug of the face seal comprises positioning the filter cover in facing engagement with the first end and sliding the filter cover across the first end.

15. A method for using a facemask assembly, the method comprising:
filling a pan with hot water;
dipping a face portion of a face seal of the facemask assembly into the hot water for a first time duration to soften the face portion; and
pressing the face portion against a face of a user to form a seal between the face portion and the face until the face portion hardens after a second time duration.

16. The method of claim 15, further comprising coupling a filter assembly of the facemask assembly to the face seal and sealing the face seal with the face of the user.

17. The method of claim 15, wherein filling the pan with hot water comprises filling the pan with water and bringing the water to a boil.

18. The method of claim 15, further comprising dipping the face portion into room temperature water for a third time duration after dipping the face portion of the face seal of the facemask assembly into the hot water and before pressing the face portion against the face of the user.

19. The method of claim 18, wherein the first time duration is longer than the second time duration, and wherein the second time duration is longer than the third time duration.

20. The method of claim 15, wherein the face portion comprises an amorphous solid.
